(19) United States
(12) Patent Application Publication
(10) Pub. No.: US 2019/0161815 A1
(43) Pub. Date: May 30, 2019

(54) PROBIOTIC COMPOSITION AS LEATHER AUXILIARY AGENTS AND USE THEREOF

(71) Applicants: PROKLEAN TECHNOLOGIES PVT. LTD, Chennai (IN); SUSTAINABLE COMMUNITY DEVELOPMENT, LLC, Kansas City, MO (US)

(72) Inventors: Sivaramakrishna Pillai SANKARAKUMARA PILLAI, Chennai (IN); Matthew Wood, Kansas City, MO (US); Narin Tipsrisukond, Kansas City, MO (US)

(21) Appl. No.: 15/580,608

(22) PCT Filed: Jun. 8, 2016
(86) PCT No.: PCT/IN2016/050174

§ 371 Date: Dec. 7, 2017

(30) Foreign Application Priority Data
Jun. 9, 2015 (IN) 2871/CHE/2015

(51) Int. Cl. C14C 3/26; C14C 1/04; C14C 9/00

(52) U.S. Cl. CPC C14C 3/26; C14C 9/00; C14C 1/04

(57) ABSTRACT

The present invention describes a fully bio-degradable probiotic composition and its method of use as leather tanning auxiliary to offer a green technology to reduce waste and increase the value of by-products reducing the need of synthetic chemicals and improving the quality of effluents. Probiotics or beneficial microorganisms are used to obtain biochemicals through a controlled fermentation of natural ingredients. The result of the process is a consortium of metabolites used in conjunction with probiotic bacteria wherein product has properties very similar to traditional leather auxiliaries extensively used during the leather making process, such as wetting, dispersing, degreasing and solubilizing agents. Therefore, they have clear applications not only in the beam house operations, but also in wet-end and finishing.

### FIELD OF THE INVENTION

The present invention relates to a fully bio-degradable probiotic composition as leather auxiliary agents composition comprising, one or more of wetting, dispersing, and/or solubilising agents mixed in suitable proportions characterized by fermentation broth including but not limited to organic acids such as acetic acid, lactic acid, fatty acids small chain peptides, biopolymers and other compounds such as vitamins and polyols with a MALDI-TOF mass spectra profile for wetting, dispersing, and/or solubilising agent given by FIGS. 1-3 respectively; along with total Lactic Acid Bacteria (LAB) counts between 1.0E+4 to 1.0E+6 cfu/mL; wherein final product has a pH value of <4.0 with activity in pH range from 2 to 12, percent titratable acidity expressed as Lactic Acid between 0.6-3.2; an HLB range of 13 to 18 and E 24 values between 40 and 85

It also relates to use of the bio-degradable probiotic composition at various stages of leather tanning including raw hide preservation, soaking, liming, de-liming, bating, degreasing, tanning, wetting back, fat liquoring, dyeing, finishing eliminating or reducing the need for use of toxic chemicals such as Potassium dimethyldithiocarbamate and Tetrahydro-3,5-dimethyl-2H-1,3,5-thiadiazine-2-thione, Sodium lauryl ether sulfate, Enzymes, Oxalic acid, Mercaptoetanolates, Ethoxylate Amin (EA), Ammonia, Naphthalene sulfonic compounds, and Iso-propanol alcohol (IPA).

Additionally, it relates to the improvement of quality of wastewater effluent reducing the need for use of conventional toxic chemicals for the treatment.

### BACKGROUND OF THE INVENTION

Processing hides and skins to manufacture leather involves generating very high amounts of residues, many of them valuable for other applications if they are not contaminated with chemicals.

The tanning process includes prepping a hide, removal of keratinous matter, removal of natural grease and fats, batting, and eventually tanning. During this process the composition of the invention may be used to replace chemicals typically used, or in addition to such chemicals so as to enhance the effects of the chemical. One skilled in the art will appreciate that the use of composition of the invention will depend upon the desired source of hide being tanned, the method of tanning, and the desired end product. For instance, tanning resulting in a more flexible hide may be desired for luggage and furniture, whereas a more stretchable hide may be desired for handbags and clothing.

The hide may be obtained from any animal including, for example, farm animals, game and the like. Specific animals include, without limitation, alligators, cattle, crocodile, deer, elk, goats, kangaroos, ostriches, oxen, pig, sheep, snakes, oxen, and yak. The hide may consist of both the top grain layer and the split leather or either layer separately.

Tanneries working under the best available techniques and good practices consume more than 35 cubic meters of water to transform one ton of bovine raw material into 250 kg of leather for the manufacture of articles such as shoes, apparel, furniture or car upholstery, bags, belts, etc.

During the process, the tanneries consume at least 200 kg of reacting chemicals that contribute to the final properties of the leather according its purposes of usage, such tanning agents, dyes, fat liquors, etc. Additionally, 300 kg of auxiliary chemicals are required to prepare the hides and skins for tanning and each step of leather processing. These chemical auxiliaries, among all the substances contained in the hides and skins, which are not suitable to be converted in leather, like manure, grease, unstructured proteins and keratin from hair, have to be eliminated through the effluents. The excess of reactive chemicals is also eliminated through the effluents. Therefore, the wastewater of the leather industry has to be treated before discharging them into natural water streams and demands high amounts of oxygen to degrade all contaminants. The waste water also contains huge amounts of salts and nitrogen compounds that should be eliminated to fulfill environmental restrictions currently obliged in most of the countries in the world and by international organizations.

Alternate technology offered comes in form of probiotics. Probiotics are beneficial microorganisms, like live bacteria and yeasts or their metabolites that provide health to humans and living beings. Probiotics of today find an array of new applications in agriculture, animal care, soil remediation, water treatment, cosmetics and many other fields.

### SUMMARY OF THE INVENTION

The present invention through its embodiments and examples provides a fully bio-degradable probiotic composition as leather auxiliary agents compositions comprising, one or more of wetting, dispersing, and/or solubilizing agents mixed in suitable proportions with a deodorizer extracted from essential oils and additives required to keep the entire formulation stable over a period of one year or more; characterized by a fermentation broth including but not limited to organic acids such as acetic acid, lactic acid, fatty acids, small chain peptides, biopolymers and other compounds such as vitamins and polyols with a MALDI-TOF mass spectra profile for wetting, dispersing, or solubilising agent given by FIGS. 1-3 respectively; along with total Lactic Acid Bacteria (LAB) counts between 1.0E+4 to 1.0E+6 cfu/mL; wherein final product has a pH value of <4.0 with activity in pH range from 2 to 12, percent titratable acidity expressed as Lactic Acid between 0.6-3.2; an HLB range of 13 to 18 and E 24 values between 40 and 85.

It also provides bio-degradable probiotic composition used at various stages of leather tanning including preservation of raw hides, soaking, liming, de-liming, bating, degreasing, tanning, wetting back, fat liquoring, dyeing, finishing thereby eliminating or reducing the need for use of toxic chemicals such as Potassium dimethyldithiocarbamate and Tetrahydro-3,5-dimethyl-2H-1,3,5-thiadiazine-2-thione, Sodium lauryl ether sulfate, Enzymes, Oxalic acid, Mercaptoetanolates, Ethoxylate Amin (EA), Ammonia, Naphthalene sulfonic compounds, and Iso-propanol alcohol (IPA).

The novel fermentation products include wetting, dispersing, and/or solubilizing agents characterized by MALDI-TOF profile as given in FIGS. 1-3, with the improved formulation vis a vis previous formulations sold under product name as ProSoak™, ProSpread™ and ProDegreaze™, respectively. The final bio-degradable probiotic composition used as leather auxiliary agents comprise not only biochemicals/metabolite broth, but also viable probiotic microorganisms.

The final composition has surfactant-like and emulsifying properties with an HLB range of 13 to 18 and E 24 values between 40 and 85. Additionally, it has a pH value of <4.0 with an activity range from pH 2 to 12, percent, titratable acidity expressed as Lactic Acid between 0.6-3.2, with Total Lactic Acid Bacteria (LAB) counts between 1.0E+4 to 1.0E+6 cfu/mL.

In embodiments of the invention the bio-degradable probiotic composition is useful not only in the abattoir, beam house operations, but also in wet-end and finishing.

In an embodiment of the invention biocidal chemicals such as Potassium dimethyldithiocarbamate, and Tetrahydro-3,5-dimethyl-2H-1,3,5-thiadiazine-2-thione typically used in the tanning process are not needed, and are preferably excluded, when any of the fermentation products including wetting, dispersing, and/or solubilizing agents is applied in the leather tanning process such as pre-soaking and/or soaking.

In an embodiment of the invention surfactant chemicals such as anionic, cationic and/or non-ionic surfactants; degreasing chemicals and/or enzymes such as lipases, anionic, cationic and/or non-ionic degreasing agent; lime dispearsing agents such as amines and organic reductive agents; dye auxiliaries such as naphthalene sulfonic compounds; solvents such as IPA, typically used in the tanning processes are not needed, and are preferably excluded and/or are reduced, when any of the fermentation products including wetting, dispersing, and/or solubilizing agents is applied in the leather tanning process such as pre-soaking, soaking, liming, de-liming, bating, degreasing, tanning, wetting back, fat liquoring, dyeing, and finishing.

In embodiments of the invention, the bio-degradable probiotic composition is effective at a ratio of between 0.2 parts to 5 parts dissolved in 100 litres of water.

In yet another embodiment of the invention the bio-degradable probiotic composition improves evenness, intensity and exhaustion of dye and reduces COD, total sulphates and total nitrogen of dye effluent.

Provided herein are novel fermentation products of a microorganism consortium, where the fermentation product comprises metabolites including not limited to, organic acids such as acetic acid, lactic acid, fatty acids, small chain peptides, biopolymers and other compounds such as vitamins and polyols, where the microorganism consortium comprises probiotic microbes selected from species of Bacillus, Bifidobacterium, Lactobacillus, Lactococcus, Rhodopsuedomonas, Sacharomyces, Streptococcus, Purple sulphur bacteria, Lactic acid bacteria and Yeast.

The present invention refers to wetting, dispersing, and/or solubilizing agents characterized as having a pH value of <4.0 with activity in pH range of 2 to 12, percent Titratable Acidity expressed as Lactic Acid between 0.6-3.2, with Total Lactic Acid Bacteria (LAB) counts between 1.0E+4 to 1.0E+6 cfu/mL.

Additionally, the final composition has surfactant-like and emulsifying properties with an HLB range of 13 to 18 and E 24 values between 40 and 85. Wetting, dispersing, and solubilizing agents are characterized by the MALDI-TOF profile given in FIGS. 1 to 3, respectively, where each has unique profile from one another.

The fermentation products disclosed herein are useful as partial or complete chemical replacements. The present invention encompasses methods of benefiting an environment that would benefit from a microorganism composition. The methods may be used to replace and/or reduce the need of chemical compositions, such as chemicals used in leather tanning.

### BRIEF DESCRIPTION OF THE DRAWINGS

FIGS. 1-3 illustrate MALDI-TOF profiles of wetting, dispersing, and solubilizing agent respectively as analyzed by Voyager DE STR MALDI-TOF MS system, Applied Biosystems, using Data Acquisition software, Voyager Version 5.10.3.

FIG. 4 illustrates Comparative Dyeing Profiles of Samples indicating improved both intensity and evenness of the dye using probiotic composition.

FIG. 5 illustrates Comparative Fixation Profiles of Samples

The comparative samples of the final floats after fixation of the dye with the bio-degradable probiotic composition of present invention indicating that dye was mostly fixed to the leather material, contributing to the least contaminants to the effluent.

FIG. 6 illustrates Comparative Evenness Analysis of Samples showing that the present invention improves evenness compared with traditional dyeing auxiliaries and influences positively in the results because evenness increases at higher concentration, contrary to EA and ammonia.

FIG. 7 illustrates Comparative Intensity Analysis of Samples showing that the present invention improves intensity compared with traditional dyeing auxiliaries and influences positively in the results because evenness increases at higher concentration.

FIG. 8 illustrates Comparative Exhaustion Analysis showing that chemical dyes auxiliaries delay the fixation of the dyes in the leather and, therefore, reduce their fixation in the leather fibers and exhaustion. The present invention has a limited dispersing effect on the dyes but increase their solubility to uniform the dyeing behavior when dyes are blended to obtain specific shades. The bleaching effect of the dye auxiliaries is minimized and has very little influence is the dye fixation.

FIG. 9 illustrates Chemical demand of oxygen (COD) expressed in mg 02/L showing that chemical dye auxiliaries contribute to higher chemical demand of oxygen, while present invention is able to reduce the values even more, at higher concentrations of product.

FIG. 10 illustrates Total nitrogen: expressed in mg NT/L showing that EA and ammonia contribute to higher levels of nitrogen in the effluents as compared to present invention.

FIG. 11 illustrates Total sulfates expressed in mg SO4²⁻/L showing that origin of sulfates comes from dyestuffs but also, from traditional dye auxiliaries, specially, naphthalene sulfonic salts.

FIG. 12: Spray application on colourless chromium crust showing comparative intensity analysis. It is observed that the present invention improves intensity compared to conventional dispersing chemical.

FIG. 13: Colour fastness to cycles of to-and-fro rubbing (ISO 11640/IUF 450) showing comparative intensity analysis. It is observed that the present invention facilitates dye fixation as equal to the conventional chemical IPA

FIG. 14: Leather with impregnation was dried and finished in a black patent shoe article and illustrates that the present invention can be used as dye impregnator providing higher effectiveness comparing to the conventional chemical used.

FIG. 15: Determination of flex resistance: flexometer method. ISO 5402-1/IUP 20-1. Results show that finishing coats are not stripped with the flexions. The outcome using the present invention is similar to conventional chemical solvent use.

FIG. 16: Test adhesion for finish—ISO 11644/IUF showing comparative results between the present invention versus the conventional chemical use. Dye adhesion results are similar between the two treatments

### DETAILED DESCRIPTION

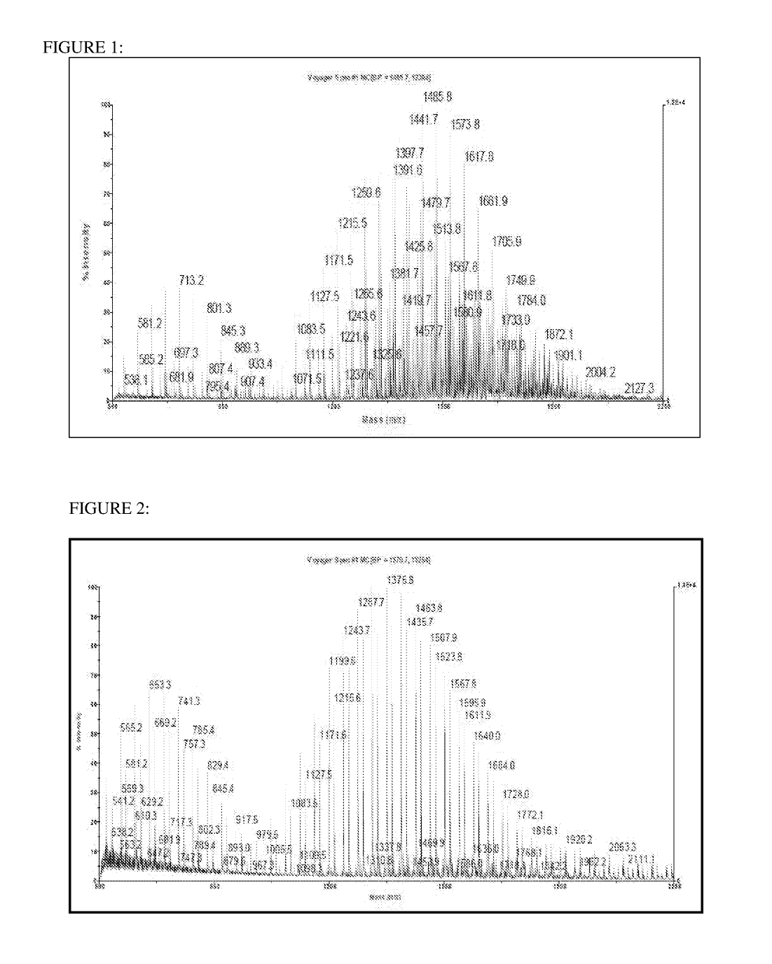

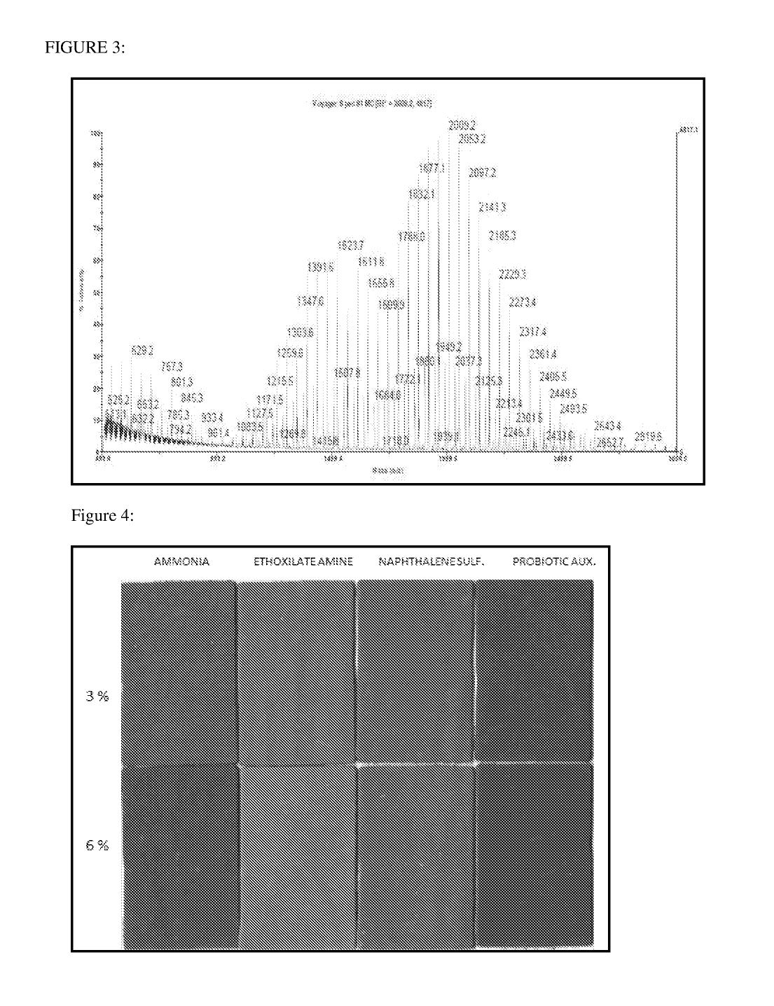

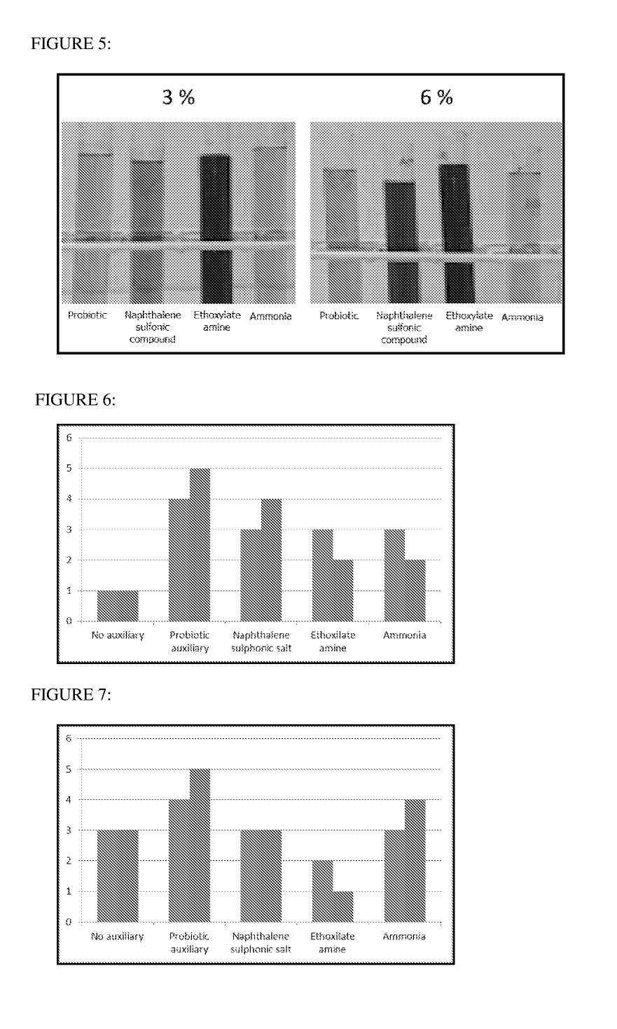

The present invention describes bio-degradable probiotic compositions as leather auxiliary agent for tanning comprising, one or more of wetting, dispersing, and/or solubilizing agents mixed in suitable proportions with a deodorizer extracted from essential oils and additives required to keep the entire formulation stable over a period of one year or more. The present invention is characterized by fermentation broth including not limited to organic acids such as acetic acid, lactic acid, fatty acids, small chain peptides, biopolymers and other compounds such as vitamins and polyols with a MALDI-TOF mass spectra profile for wetting, dispersing, solubilising agent given by FIGS. 1-3 respectively; along with total Lactic Acid Bacteria (LAB) counts between 1.0E+4 to 1.0E+6 cfu/mL; wherein final product has a pH value of <4.0 with activity in pH range from 2 to 12, percent titratable acidity expressed as Lactic Acid between 0.6-3.2; an HLB range of 13 to 18 and E 24 values between 40 and 85.

It also describes a method of tanning leather comprising contacting a hide with a bio-degradable probiotic composition comprising as leather auxiliary agent for tanning comprising, one or more of wetting, dispersing, and/or solubilizing agents mixed in suitable proportions characterized by fermentation broth including not limited to organic acids such as acetic acid, lactic acid, fatty acids, small chain peptides, biopolymers and other compounds such as vitamins and polyols with a MALDI-TOF mass spectra profile for wetting, dispersing, solubilising agent given by FIGS. 1-3 respectively; along with total Lactic Acid Bacteria (LAB) counts between 1.0E+4 to 1.0E+6 cfu/mL; wherein final product has a pH value of <4.0 with activity in pH range from 2 to 12, percent titratable acidity expressed as Lactic Acid between 0.6-3.2; an HLB range of 13 to 18 and E 24 values between 40 and 85.

MALDI-TOF Spectrum Analysis

The fermentation products were analyzed for their fingerprint characterization using a Voyager DE STR MALDI-TOF MS system. Three different embodiments were analysed: the novel fermentation product as a wetting, dispersing, or solubizing agent. Applied Biosystems, using Data Acquisition software, Voyager Version 5.10.3. Five analyses were conducted in positive mode over the following ranges; 50-1,000, 500-5,000, 3,000-12,000, 10,000-80,000 and 10,000-150,000 m/z. The compositions were screened in negative mode for each mass range. Post-acquisition processing was done using the software, Data Explorer Version 4.0. Commercial mass standard solutions or bovine serum albumin were used to calibrate the sample spectra. Mass standards were analyzed for each m/z range and were internally calibrated. The sample spectra were externally calibrated with adjacent mass standards.

Calculation of HLB

A range of HLB values were created by mixing 1.5 ml of emulsifiers with different ratios of Span 80 (HLB=4) to product. Distilled water (27 mL) was added to all the tubes along with 1.5 ml of oil with an HLB value of 6 followed by vigorous shaking for 20 seconds. The tubes were incubated for 24 hours and the HLB value for the unknown sample was calculated using the formula

HLB of test sample=(6−Percent of Span 80(%)×4)/Percent of Product (%))

Calculation of Emulsification Index E24 of Sample

Four mL of test sample or control were taken to which equal quantity of petrol was added. This solution was vortexed for 2 minutes and allowed to stand for 24 hours. Control used was 3.5 ml of water, with 0.5 ml of TritonX100. The E24 was given as the percentage of height of the emulsified layer (mm) divided by the total height of the liquid column (mm).

Methods of tanning leather are contemplated that use the compositions of the invention. In particular, methods of tanning leather that replace and/or reduce a chemical typically used in the tanning process with a bio-degradable composition of the invention are contemplated.

The tanning process includes prepping a hide, removal of keratinous matter, removal of natural grease and fats, batting, and eventually tanning. During this process the bio-degradable compositions of the invention may be used in lieu of chemicals typically used, or as additives to enhance the effects of the conventional chemicals. One skilled in the art will appreciate that the use of compositions of the invention will depend upon the desired source of hide being tanned, the method of tanning, and the desired end product. For instance, tanning resulting in a more flexible hide may be desired for luggage and furniture, whereas a more stretchable hide may be desired for handbags and clothing.

The hide may be obtained from any animal including, for example, farm animals, game and the like. Specific animals include, without limitation, alligators, cattle, crocodile, deer, elk, goats, kangaroos, ostriches, oxen, pig, sheep, snakes, oxen, and yak. The hide may consist of both the top grain layer and the split leather or either layer separately.

In some aspects, the fermented composition with additives is provided alone as a replacement for chemicals typically used in the tanning process. Examples of chemicals that can be replaced include, without limitation, Potassium dimethyldithiocarbamate, and Tetrahydro-3,5-dimethyl-2H-1,3,5-thiadiazine-2-thione, essentially used as bactericide. In other aspects the fermentation product is provided in combination with another conventional tanning agent at reduced usage rates. Examples of tanning agents that may be provided with the present invention include enzymes, anionic, cationic and/or non-ionic surfactants/degreasing agents, tannins, chromium tanning reagents, aluminum tanning reagents, lime dispersing agents, dye auxiliaries, organic acids, inorganic solvents as well as others known in the art.

The method comprises contacting the compositions of the invention with the animal hide. Contacting can be accomplished in a variety of ways. In some embodiments, the hide is submerged in the liquid formulation, in other aspects the dry formulations are wetted to produce a paste, which is coated onto the hide. In some embodiments, several hides are submerged in a liquid formulation containing the present invention in a rotating drum.

The amount of time that the composition is contacted with the animal hide can and will vary depending on the type of hide being contacted and the desired qualities of the resulting tanned hide, including the amount of penetration desired. In some aspects, the hide is contacted with the composition for a period ranging between about 1 hour to 10 days. In some aspects, the process is repeated one or more times to achieve the desired tanning.

Stages of tanning wherein bio-degradable probiotic composition of present invention are employed include

1. Soaking: Dosing ranges may depend on raw hides and skins origins, breed, genre, season, preservation method and conditions, and tannery equipment. Suggested usages are as the follows:
Washing: 1-2 g/L the novel composition as a wetting agent
Presoaking: 3-5 g/L the novel composition as a dispersing agent+0-1 g/L the novel solubilizing agent
Main soaking: 3-5 g/L the novel composition as a wetting agent+0-3 g/L the novel solubilizing agent

2. Liming: To help lime dispersion and penetration into the collagen fibres. A regular swelling is achieved, with less wrinkles. Dosing 2 g/L the novel composition as a dispersing agent at the beginning of unhairing-liming process.

3. De-liming: Dosing up to 3 g/L of the novel composition as a solubilizing agent at the latest washes to neutralize lime and disperse and eliminate remaining fats from mechanical degreasing (fleshing).

4. Bating: Dosing up to 2 g/L of the novel composition as a solubilizing agent for degreasing and cleaning grain side of hides and skins.

5. Degreasing: for skins with very high amount of fat like sheep or pig skins. Dosing 3-5 g/L of the novel composition as a solubilizing agent, when skins are pickled or after depickling in combination with a anionic or non-ionic surfactant agent with good emulsifying properties. Normally, operation is repeated twice or three times.

6. Tanning:
Chrome: Dosing 2-3 g/L of the novel composition as a dispersing agent before the addition of the chromium tanning salts.
White: Dosing 3-5 g/L of the novel composition before the tanning agent (glutaraldehyde or other organic compounds)
Vegetable: Dosing 3-g g/L of the novel composition together with the vegetable tannin or extract.

7. Washing/wetting back: Dosing 1 percent-2 percent on leather shaved weight (wet-blue, wet-white or vegetable leather) of the novel composition as a dispersing, wetting or solubilizing agent depending on leather condition) or 2 percent-4 percent on dried weight if leather are dried after tanning.

8. Retanning/fat liquoring: Dosing half of main retanning or fatliquor before or during the retanning or fat liquoring operation.

9. Dyeing: Dosing half of dye for dark or medium shades or same amount of dye for pastel shades before or together with the dye in the main or top dyeing.

10. Finishing: the present invention can help to reduce or eliminate solvents in some coating applications like: dosing 20-200 g/L of coating solution.

11. Spray dyeing/pigmenting: the present invention can be used with finishing dyes to adjust the shades and enhancing the final appearance of leather articles by improving the intensity and brightness of the colours. As probiotic compositions do not contain VOC, they are an environmental solution for restricted solvents, especially suitable in high performing articles like automotive and aviation leather. Present invention does not leave a harsh feel on the surface finished leather like solvents.

12. Impregnation: the present invention is suitable to be used as penetrating agent of impregnation of leather finishing coats. They do not affect the physical properties of flex resistance and adhesion of the finishing layers. Therefore, solvents which involve VOCs are not necessary.

The following examples are illustrated to show the working of the probiotic composition vis a vis its chemical equivalents

### EXAMPLES

### Example 1: Use of Present Invention as a Soaking Aid

In a Spanish tannery 168 heavy fresh domestic hides, 7600 kg (average 40-50 Kg/piece), were processed in parallel with standard production methods using traditional chemical auxiliaries. The aim was to assess the improvement of the limed pelts and the contamination of the effluent through the COD analysis of all drained floats.

The tannery standard process requires pre-washing with water previous to the presoaking. A surfactant, based on fatty alcohol ethoxylate and a bactericide are added in the presoaking and in the main soaking. After soaking, hides followed the standard tannery process of unhairing with hair-saving technology, liming and fleshing. No bad odor or putrefaction is observed.

The results of the soaking process executed with the present invention are given in table 1 with percentages calculated on the basis of raw weight:

TABLE 1

| | | | Time | Control | | |
|---|---|---|---|---|---|---|
| PROCESS | percent | Product | Minute | T ° C. | pH | Be |
| Pre- | 150 | Water | | 20 | | |
| soaking | −0.25 | Probiotic dispersing | 60 | | 7.6 | |
| | | agent | | | | |
| Drain | | | | | | |
| Main | 150 | Water | | | | |
| Soaking | 0.3 | Probiotic soaking | 60 | | | |
| | | agent | | | | |
| | 0.5 | Soda ash | 120 | | | |
| | | automatic (5 min/2 h) | 120 | | | |
| | | automatic (5 min/2 h) | 120 | | | |
| | | automatic (5 min/2 h) | 120 | | | |
| | | Overnight automatic | | | | |
| | | (5 min/2 h) | | | | |

The analytical values for reduction in COD using bio-degradable probiotic composition of present invention are shown in table 2:

TABLE 1
COD values in mg 02/L

| Process float | Std. | Probiotic | Reduction |
|---|---|---|---|
| Prewashing | 2,760 | | |
| Pre-soaking | 6,420 | 5,360 | 17 percent |
| Main-Soaking | 9,880 | 8,380 | 15 percent |
| Unhairing | 92,444 | 53,378 | 42 percent |
| Liming | 63,508 | 27,787 | 56 percent |
| 1^{st} wash | 3,940 | 3,420 | 13 percent |
| 2^{nd} wash | 4,500 | 3,440 | 24 percent |

Further, not only was the concentration of chemical oxygen demand lower in all the floats. Considering also the volumes of water use to process 1 metric tons of hides, the reduction on COD was also exceptional as indicated in Table 3.

TABLE 2
COD values in kg O2/Ton of hides

| Process float | percent Water | Std. | Probiotic | Reduction |
|---|---|---|---|---|
| Prewashing | 150 | 4 | | |
| Pre-soaking | 150 | 10 | 8 | 17 percent |
| Main-Soaking | 150 | 15 | 13 | 15 percent |
| Unhairing | 50 | 46 | 27 | 42 percent |
| Liming | 80 | 51 | 22 | 56 percent |
| 1^{st} wash | 150 | 6 | 5 | 13 percent |
| 2^{nd} wash | 150 | 7 | 5 | 24 percent |
| | | 138 | 80 | 42 percent |

The control of the lime pelts after fleshing reported that hides were clean and more relaxed that normal production, no drawn marks, shallower growth winkles, without false backs. Wet blue was very uniform and fuller in the flanks. Quality control analysis reported values of content of Cr₂O₃ and matter soluble in dichloromethane and free fatty acid within customer specifications. Crust was also evaluated and reported as slightly softer, better evenness and color intensity covering natural grain defects.

Another set of results show that high microbial counts found in soaking baths containing the present invention do not adversely affect the quality of the hide after soaking or after wet blue conversion (Table 4 and 5).

To further emphasize the outcomes, blind sample trials with the highest amount of bacterial counts in soaking baths, Trial 12 (22.7×10⁷ cfu/ml), were compared to the lowest amount of bacterial counts in soaking baths, Trial 10 (5.0×10⁵ cfu/ml), and there was no sign of hide damage caused by bacterial attack after soaking and after wet blue conversion (Table 4). In addition, the quality of the wet blues from Trial 12 and Trial 10 are equal (Table 4). There were 20 blind testing trials in total.

In each trial run, the raw hide was prewashed for 30 minutes with the present invention. Subsequently, it was subjected to a soaking process with the novel wetting and/or dispersing agent for up to 8 hours. Table 4 indicates the degree of soaking efficiency as well as bacterial load data. Under normal conditions, it would be recommended that a bactericide product should be used since all bacterial counts in soaking exceed their limit of 2.0×10⁵ cfu (Table 4). However, in the presence of the present invention without the use of bactericides such as Potassium dimethyldithiocarbamate, and Tetrahydro-3,5-dimethyl-2H-1,3,5-thiadiazine-2-thione, very good results were achieved.

All hides from the soaking process were then processed to wet blues. All processed wet blues had a good degree of tanning and showed no problem with shrinkage or with boiling tests. The pH, percent chromium oxide and fat contents were within the recommended range (Table 5). Likewise, through visual inspection, all wet blues were normal and acceptable to standards.

TABLE 4
Evaluation of the degree of soaking efficiency
and biological analysis of soaking baths.

| Trial Run | Soaking Efficiency | Bacterial Count (cfu/ml) |
|---|---|---|
| 1 | Good | 860,000 |
| 2 | Regular | 6,450,000 |
| 3 | Regular | 9,550,000 |
| 4 | Good | 10,800,000 |
| 5 | Good | 9,700,000 |
| 6 | Good | 11,100,000 |
| 7 | Good | 8,400,000 |
| 8 | Good | 5,800,000 |
| 9 | Good | 5,500,000 |
| 10 | Good | 500,000 |
| 11 | Good | 17,200,000 |
| 12 | Good | 22,700,000 |
| 13 | Good | 600,000 |
| 14 | Good | 900,000 |
| 15 | Good | 14,500,000 |
| 16 | Good | 8,400,000 |
| 17 | Good | 7,700,000 |
| 18 | Good | 13,900,000 |
| 19 | Good | 9,800,000 |
| 20 | Good | 4,500,000 |

TABLE 5
Evaluation of Chrome Tanned Leather and Chemical Analyses

| | | Chemical Analysis | | |
|---|---|---|---|---|
| | | | percent | |
| | | | Chromium | percent |
| Trial Run | Degree of Tanning | pH | Oxide | Fat |
| 1 | Good | 3.86 | 3.2 | 1.1 |
| 2 | Good | 3.49 | 3.5 | 1.9 |
| 3 | Good | 3.54 | 5.0 | 1.1 |
| 4 | Good | 3.41 | 3.3 | 1.2 |
| 5 | Good | 3.44 | 3.4 | 1.3 |
| 6 | Good | 3.54 | 3.3 | 1.3 |
| 7 | Good | 3.43 | 3.9 | 0.8 |
| 8 | Good | 3.62 | 3.8 | 0.7 |
| 9 | Good | 3.43 | 4.1 | 0.8 |
| 10 | Good | 3.58 | 2.9 | 0.9 |
| 11 | Good | 3.48 | 3.4 | 0.8 |
| 12 | Good | 3.42 | 3.1 | 0.9 |
| 13 | Good | 3.44 | 3.3 | 0.7 |
| 14 | Good | 3.47 | 3.3 | 0.9 |
| 15 | Good | 3.50 | 4.2 | 0.5 |
| 16 | Good | 3.55 | 4.3 | 0.6 |
| 17 | Good | 3.65 | 4.4 | 0.7 |
| 18 | Good | 3.34 | 2.9 | 1.2 |
| 19 | Good | 3.34 | 3.3 | 1.6 |
| 20 | Good | 3.38 | 3.4 | 1.0 |

Five pieces of heavily salted Mexican cow hides (previously stored for more than 100 days in the warehouse) with total weight of 150 Kg were processed with the present invention in pre-soaking and soaking operations. It is observed that the process time of pre-soaking was reduced from 16 hours to 8 hours (Table 6). This is considered a significant improvement from the previous discovery. Wet blue articles were subsequently produced through conventional chrome tanning. The finished articles met the standard and were comparable to the wet blue processed with conventional soaking chemicals.

TABLE 6
Test soaking on very dry and difficult raw
material using the present invention

| | | | | Process | |
|---|---|---|---|---|---|
| | | | Time | Control | |
| Process | % | Product | Minutes | ° C. | pH |
| Pre-washing | 100 | Water | | | |
| | 0.05 | Probiotic dispersing | 30 | 25 | |
| | | agent | | | |
| | 0.10 | Probiotic wetting agent | 8 | 25 | |
| Pre-soaking | 100 | Water | | | 8.5 |
| | 0.20 | Probiotic dispersing | 30 | | |
| | | agent | | | |
| | 0.10 | Soda ash | 2 | | |
| Green fleshing | | | | | |
| Main soaking | 100 | Water | | | 10.5 |
| | 0.20 | Probiotic wetting agent | 60 | | |
| | 0.20 | Probiotic wetting agent | | | |
| | 0.20 | Perlvit MN | 360 | | |

### Example 2: Effects of Dispersant and Solubilizer from Present Invention

A standard bovine wet-blue was selected and prepared according to the method summarized in table 7 wherein percentages are calculated on the basis of wet blue weight. The crust leather was cut into A3 pieces for wetting back as given in table 8 and for testing as given in table 9 (percentages in tables 8 and 9 expressed for dried weight)

TABLE 7

| | | | Time | Control | |
|---|---|---|---|---|---|
| PROCESS | percent | Product | Minutes | T ° C. | pH |
| Washing | 200 | Water | | 35 | |
| | 0.2 | Oxalic acid | 30 | | 3.7 |
| Drain | | | | | |
| Neutralizing | 150 | Water | | 30 | |
| | 2 | Sodium Formate | 15 | | |
| | 0.5 | Sodium bicarbonate | 60 | | 5.5 |
| Drain | | | | | |
| Washing | 200 | Water | 15 | 30 | |
| Drain | | | | | |
| Retainning | 50 | Water | | 20 | |
| | 10 | Syntan | 60 | | |
| | 10 | Sulfatatefatliqour | 120 | | |
| | 2 | Formic acid 85 percent | 60 | | 3.5 |
| Drain | | | | | |
| Washing | 200 | Water | 15 | 30 | |

Drain. Set-out. Dry. Condition. Stake

TABLE 8
.percent are calculated Dried Weight

| | | | Time | Control | |
|---|---|---|---|---|---|
| PROCESS | percent | Product | Minutes | T ° C. | pH |
| Wetting back | 1000 | Water | | 30 | |
| | 2 | Wetting agent | 120 | | 6.5 |
| Drain | | | | | |
| Washing | 1000 | Water | 20 | 30 | |
| Drain | | | | | |

TABLE 9

| | | | Time | Control | |
|---|---|---|---|---|---|
| PROCESS | percent | Product | Minutes | T ° C. | pH |
| Dyeing | 300 | Water | | 50 | |
| | X | Auxiliary | 10 | | Check pH₁ |
| | 4 | Olive dye | | | |
| | 1 | Formic acid 85 | 15 | | |
| | | percent | | | |
| | 1 | Formic acid 85 | 30 | | Check pH₂ |
| | | percent | | | |

Drain. Set-out. Dry. Condition. Stake

Typical dye auxiliaries like Naphthalene sulfonic salt, Ethoxylate amine and Ammonia were selected along with probiotic composition and added to the drums 10 minutes before the dye at 3 percent and 6 percent concentration based on dried weight. A blank with no auxiliaries was also run as a control.

In the wetting back, a fatty alcohol ethoxylate at 85 percent concentration was used as wetting auxiliary. To the crust pieces for the probiotic tests, the same product was used for wetting back and dyeing. The crusts were dyed with a commercial olive, mixture of anionic dyes. Initial pHs were not adjusted.

The initial pH (pH₁) according to dye auxiliaries are given in Table 10. All samples were eventually adjusted to a final value of pH 3.5 (pH₂)

TABLE 10

| Dye auxiliary | Conc. | pH₁ | pH₂ |
|---|---|---|---|
| Black | — | 6.70 | 3.50 |
| Probiotic aux. | 3 | 5.80 | 3.50 |
| Probiotic aux. | 6 | 7.78 | 3.50 |
| Naphthalene sulfate | 3 | 7.06 | 3.50 |
| Naphthalene sulfate | 6 | 7.00 | 3.50 |
| Ethoxy. Amine | 3 | 6.80 | 3.50 |
| Ethoxy. Amine | 6 | 6.84 | 3.50 |
| Ammonia | 3 | 10.85 | 3.50 |
| Ammonia | 6 | 11.80 | 3.50 |

To evaluate the performance of the dyeing parameters like evenness, intensity of the dyeing and dye penetration the tanned hides were evaluated by five leather experts. Results were graded with value of 5 being the highest and 1 being the lowest grade awarded. The values tabulated are averages to satisfy statistical significance of results. Samples of the effluents were chemically analyzed in the laboratory to determine COD and total nitrogen according internal method (Merck kit) and sulfates through ionic chromatography.

Table 11 summarizes the results indicating that the probiotic auxiliary of present invention ranks high in parameters like dye exhaustion, evenness and intensity offering a green solution by reducing N2 and SO4 and DQO.

TABLE 11
Comparative account of chemical and probiotic
tanning auxiliaries across multiple parameters

| | per- | DQO | N₂ | SO4₂ | Exhaus- | Even- | Inten- |
|---|---|---|---|---|---|---|---|
| Dye auxiliary | cent | mgO₂/L | mg/L | g/L | tion | ness | sity |
| Black | | 5000 | 30 | 1 | 5 | 1 | 3 |
| Probiotic aux. | 3 | 4700 | 32 | 1.2 | 5 | 4 | 4 |
| Probiotic aux. | 6 | 4100 | 31 | 1.1 | 4 | 5 | 5 |
| Naphthalene sulf. | 3 | 6500 | 46 | 2.8 | 3 | 3 | 3 |
| Naphthalene sulf. | 6 | 7900 | 44 | 3.4 | 3 | 4 | 3 |
| Ethoxy. Amine | 3 | 8200 | 150 | 2.8 | 2 | 3 | 2 |
| Ethoxy. Amine | 6 | 14300 | 300 | 1.3 | 1 | 2 | 1 |
| Ammonia | 3 | 4400 | 340 | 2.1 | 5 | 3 | 3 |
| Ammonia | 6 | 5000 | 590 | 1.6 | 5 | 2 | 4 |

Legend:
5 = best;
1 = worst

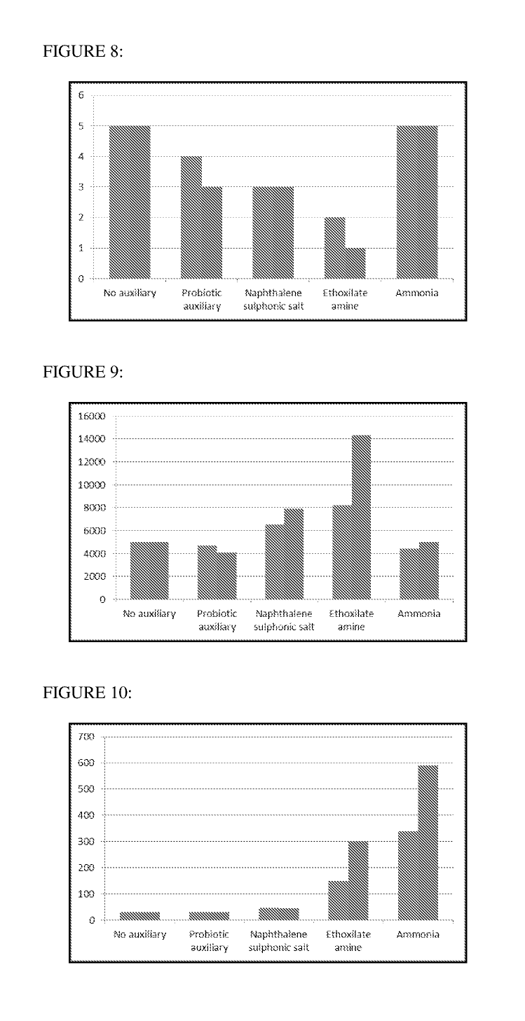

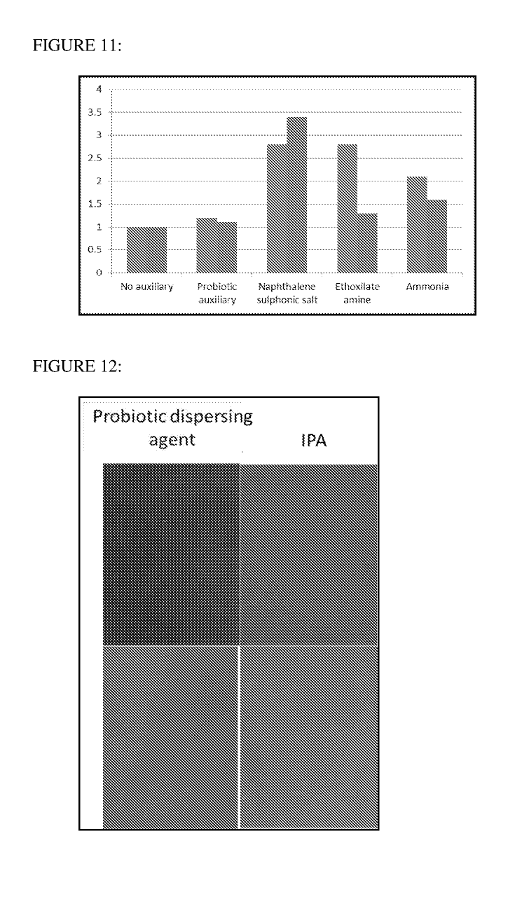

The graphics given in FIGS. 6-11 further clarify the results obtained:

### Example 3: Use of Present Invention in Spray Dyeing

Trials were conducted for substitution of the chemical dispersing agent IPA with the bio-degradable probiotic composition of the present invention for the dyeing of colourless chromium crust by spray application. The protocol involved use of 100 g/l dye along with 100 g/l Penetrating agent (the novel dispersing agent or IPA) in 800 g/l Water.

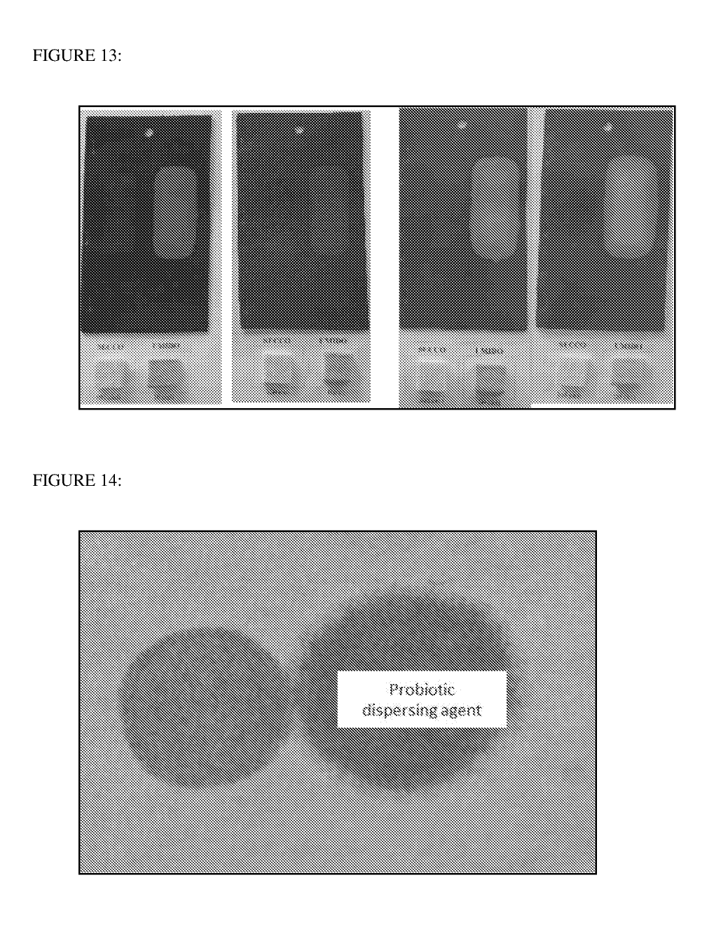

Results for black and brown dye are summarized in FIGS. 12, 13 and tables 12 and 13.

TABLE 12
Black Dye

| | | |
|---|---|---|
| Black | Probiotic | IPA |

| | | | |
|---|---|---|---|
| Dry 300 cycles | Leather | 4/5 | 4/5 |
| | Felt | 4 | 4/5 |
| Wet 10 cycles | Leather | 1/2 | 3 |
| | Felt | 1 | 1/2 |

TABLE 13
Brown Dye

| | | |
|---|---|---|
| Brown | Probiotic | IPA |

| | | | |
|---|---|---|---|
| Dry 300 cycles | Leather | 4/5 | 4/5 |
| | Felt | 4/5 | 4/5 |
| Wet 10 cycles | Leather | 1 | 1 |
| | Felt | 1/2 | 2 |

### Example 4: Use of Bio-Degradable Probiotic Composition of Present Invention to Penetrate Impregnation Compounds Before Finishing Coatings

The technique of roller coating on pieces of different thickness named as thick and thin were applied with 200 g/l penetrator (the novel dispersing agent; commercial penetrator based on solvent and surfactant), 300 g/l resin and 500 g/l water. FIG. 14 reveals that the novel dispersing agent of present invention has better wetting and dispersing properties and goes deeper. We can observe a drop on the leather. Contour with present invention is more diffused than traditional penetrator:

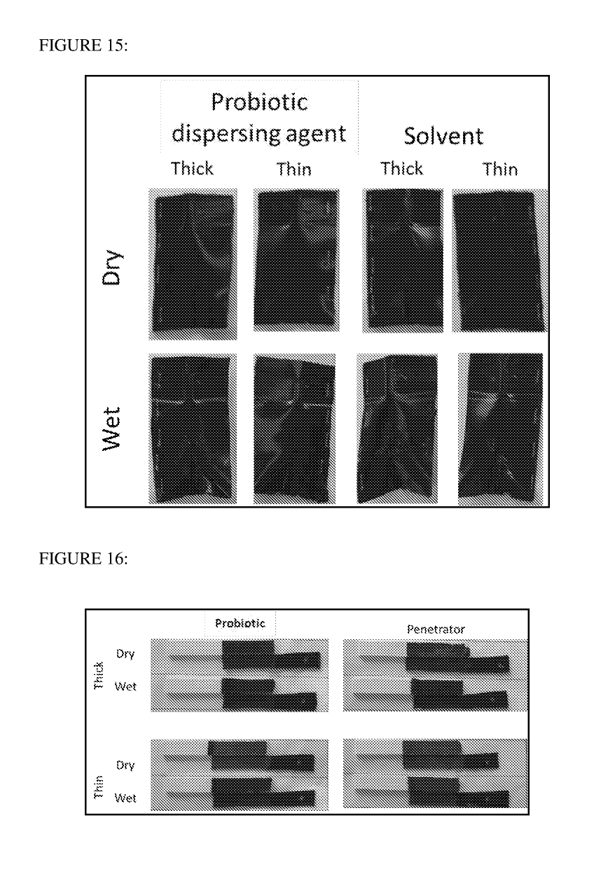

Table 14 along with FIG. 15 which gives the results of flex resistance using flexometer method as prescribed in ISO 5402-1/IUP 20-1 reveals comparable results using chemical or probiotic dispersing agent of the present invention thereby indicating that it can replace the chemical penetrator agent.

TABLE 14
Comparative analysis of chemical penetrator and
probiotic dispersing agent of present invention

| | |
|---|---|
| Probiotic | Penetrator |

| | Thick | Thin | Thick | Thin |
|---|---|---|---|---|
| Dry | >150 000 | >150 000 | >150 000 | >150 000 |
| Wet | >150 000 | >150 000 | >150 000 | >150 000 |

TABLE 15
Results are given in N/cm

| | |
|---|---|
| Probiotic | Penetrator |

| | Thick | Thin | Thick | Thin |
|---|---|---|---|---|
| Dry | 25 | 26.6 | 66.6 | 15.5 |
| Wet | 9 | 9 | 11.7 | 8.9 |

Table 15 illustrates comparative results between the present invention and conventional treatment which are very similar and the values are within acceptable ranges for both treatments.

The examples given above in the description above are representative and those conversant in the art will realize that it should not restrict the scope of the invention.

We claim:

1. A probiotic composition as leather auxiliary agent for tanning comprising, one or more of wetting, dispersing, and/or solubilizing agents mixed in suitable proportions with a deodorizer extracted from essential oils and additives required to keep the entire formulation stable over a period of one year or more; said composition characterized by fermentation broth, including not limited to organic acids such as acetic acid, lactic acid, fatty acids, small chain peptides, biopolymers and other compounds such as vitamins and polyols; total Lactic Acid Bacteria (LAB) counts between 1.0E+4 to 1.0E+6 cfu/mL; having a pH value of <4.0 active in pH range from 2 to 12, percent titratable acidity expressed as Lactic Acid between 0.6-3.2; an HLB range of 13 to 18 and E 24 values between 40 and 85; with a MALDI-TOF mass spectra profile for wetting, dispersing, solubilising agent given by FIGS. 1-3 respectively.

2. A method of tanning leather comprising contacting a hide with a bio-degradable probiotic composition comprising, one or more of wetting, dispersing, and/or solubilizing agent mixed in suitable proportions with a deodorizer extracted from essential oils and additives required to keep the entire formulation stable over a period of one year or more; characterized by fermentation broth, including but not limited to organic acids such as acetic acid, lactic acid, fatty acids, small chain peptides, biopolymers and other compounds such as vitamins and polyols; total Lactic Acid Bacteria (LAB) counts between 1.0E+4 to 1.0E+6 cfu/mL; having a pH value of <4.0 active in pH range from 2 to 12; percent titratable acidity expressed as Lactic Acid between 0.6-3.2; an HLB range of 13 to 18 and E 24 values between 40 and 85; with a MALDI-TOF mass spectra profile for wetting, dispersing, solubilising agent given by FIGS. 1-3 respectively.

3. The method of claim 2 used at various stages of leather tanning including preservation of raw hides, soaking, liming, de-liming, bating, degreasing, tanning, wetting back, fat liquoring, dyeing, finishing wherein bio-degradable probiotic composition comprises one or more of wetting, dispersing and/or solubilizing agents mixed in ratios ranging from 1:1 to 5:1 with concentration of individual components in ranges of 0.1-0.5 percent weight/volume.

4. A method of claim 2 replacing and/or reducing chemical biocides, dispersant and solubilizer such as Potassium dimethyldithiocarbamate, tetrahydro-3,5-dimethyl-2H-1,3,5-thiadiazine-2-thione, Sodium lauryl ether sulfate, Enzymes, Oxalic acid, Mercaptoetanolates, Ethoxylate Amin (EA), Ammonia, Naphthalene sulfonic compounds, and Iso-propanol alcohol (IPA) by contacting a hide with said probiotic composition comprising, one or more of wetting, dispersing, and/or solubilizing agent mixed in suitable proportions with a deodorizer extracted from essential oils and additives required to keep the entire formulation stable over a period of one year or more; characterized by:
fermentation broth, including not limited to organic acids such as acetic acid, lactic acid, fatty acids, small chain peptides, biopolymers and other compounds such as vitamins and polyols; total Lactic Acid Bacteria (LAB) counts between 1.0E+4 to 1.0E+6 cfu/mL; having a pH value of <4.0 active in pH range from 2 to 12, percent; titratable acidity expressed as Lactic Acid between 0.6-3.2; an HLB range of 13 to 18 and E 24 values between 40 and 85; with a MALDI-TOF mass spectra profile for wetting, dispersing, solubilising agent given by FIGS. 1-3 respectively.

5. A method of claim 2, wherein the contamination of effluents as indicated by COD, total nitrogen and sulfates can be reduced by up to greater than 45 percent as compared to conventional chemical methods.

6. A method of claim 2, wherein both intensity and evenness of the dye are significantly enhanced eliminating the use of toxic chemical such as EA and ammonia.

7. A method of claim 6, wherein the comparative samples of the final floats after fixation of the dye indicating that dye was mostly fixed to the leather material, contributing to the least contaminants to the effluent.

8. A method of claim 2, wherein fastness, fixation and impregnation of the dye during spray application are equal or enhanced eliminating the using toxic chemicals such as IPA.
